(19) United States
(12) Patent Application Publication
(10) Pub. No.: US 2006/0042670 A1
(43) Pub. Date: Mar. 2, 2006

(54) Toy for washing a rotatable object

(76) Inventors: Dominic Laurienzo, Los Angeles, CA (US); Brendon Vetuskey, Van Nuys, CA (US)

Correspondence Address: TOPE-MCKAY & ASSOCIATES, 23852 PACIFIC COAST HIGHWAY #311, MALIBU, CA, 90265, US

(21) Appl. No.: 11/182,489

(22) Filed: Jul. 14, 2005

Related U.S. Application Data
(60) Provisional application No. 60/604,283, filed on Aug. 25, 2004.

(51) Int. Cl. B08B 3/00

(52) U.S. Cl. 134/137

(57) ABSTRACT

A toy is presented for washing an object by rotating the object in a chamber of liquid. The toy comprises a chamber partially filled with liquid and includes a mount to rotationally fix an object into the chamber. The mount includes a driving element to drivingly connect with a receiving element on the object to form a driving connection. An object rotating system then imparts a rotary motion to the mount to rotate the object within the chamber of water so as to wash the object. The object rotating system is a gear and axle drivingly connected with a gear rack. The gear rack is pulled by a user to impart a rotary motion to the gear and axle, which then rotates the mount and thus the object. In another embodiment, the object rotating system is a gear and axle drivingly connected with a motor.

### PRIORITY CLAIM

The present application claims the benefit of priority of U.S. Provisional Patent Application No. 60/604,283, filed Aug. 25, 2004, entitled “Wheel Spinning Launcher and Wheel Toy.”

### BACKGROUND OF THE INVENTION

(1) Technical Field

The present invention relates to a toy for washing a rotatable object by rotating the object in a chamber of liquid, and more particularly to an object rotating system for rotationally fixing the object in the chamber and rotating the object with a gear rack.

(2) Background

Toys that use rotatable objects are well known in the art. Toys that accelerate and launch gliders, helicopters, cars, and parachutes are well documented. A typical method of rotating an object is through the use of a gear system to turn a shaft that rotates the object.

The toy of U.S. Pat. No. 3,701,216 to Smith, III, et al. discloses the use of a toy to spin and launch a wheel. During the use of the toy, the wheel is in constant contact with the ground, and when being used outdoors, can become dirty. A child playing with a dirty wheel will quickly transfer the dirt to themselves, their clothes, and anything else the child comes in contact with. Additionally, if the child is playing with the wheel outdoors and subsequently brings the wheel indoors, any dirt, mud, or oil accumulated on the wheel could be transferred to carpet, furniture or walls.

To avoid creating a mess, a parent would have to constantly monitor the child's use of the wheel and remind the child to clean it before bringing it indoors. Given a child's inherent tendency to shun cleaning, a parent may be at a loss to convince the child to keep the wheel clean.

Therefore, a need exists in the art for a method to clean a rotatable object such as a wheel that is easy to use, safe, and fun for a child.

### SUMMARY OF THE INVENTION

The present invention provides for a toy for washing a rotatable object by rotating the object in a chamber of liquid, and more particularly to an object rotating system for rotationally fixing the object in the chamber and rotating the object with a gear rack.

In one aspect, a toy for washing a rotatable object, the toy comprising a base; a chamber supported by the base, the chamber configured to contain a rotatable object and a portion of liquid; a mount connected with the chamber to affix the rotatable object in the chamber; and an object rotating system drivingly connected with the mount to impart a rotary motion to the rotatable object, whereby when the rotatable object is rotated in the chamber, the liquid washes the rotatable object.

In another aspect, the chamber is formed of plastic or acrylic.

In still another aspect, the chamber is transparent.

In a further aspect, the chamber is shaped to fit a rotatable object.

In a still further aspect, the chamber further comprises a base portion and a cover portion, the base portion connected with the base and the cover portion separable from the base portion so the rotatable object can be mounted into the chamber.

In another aspect, the mount further comprises a rotating end and a locking end, the rotating end connected with a hub of a first side of the rotatable object and the locking end connected with the hub of a second side of the rotatable object, the first and second sides of the object connected with the respective rotating end and locking end of the mount at the hub of the rotatable object.

In still another aspect, the mount is positioned within the chamber such that a rotatable object connected with the mount freely rotates in the chamber.

In yet another aspect, the rotating end of the mount comprises a driving element configured to engage a receiving element, the receiving element connected with the rotatable object to form a drive connection, such that when the driving element is rotated, the receiving element is similarly rotated.

In a further aspect, the locking end of the mount comprises a movable locking shaft for rotationally engaging and applying a force to the rotatable object, the locking end adjustable between a locked position and an unlocked position, such that when the locking end is in the locked position and rotatable object is rotated in the chamber, the rotatable object cannot be released from the mount.

In a yet further aspect, the locking end further comprises a compression spring to apply a force to the locking shaft and maintain the locking shaft in a locked position, and wherein the locking shaft further comprises a handle such that a user can pull the handle to move the locking shaft from a locked position to an unlocked position in order to load a rotatable object into the chamber.

In a still further aspect, the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

In another aspect, the edge of the driving element and the edge of the receiving element are formed as matching and interlocking shapes, such that when the edge of the driving element is matched with the edge of the receiving element, an interlocking drive connection is formed.

In still another aspect, the edge of the driving element and the edge of the receiving element are formed as hook shapes, such that when the edge of the driving element is matched up with the edge of the receiving element, an interlocking drive connection is formed.

In yet another aspect, the object rotating system further comprises a gear and an axle, the gear drivingly connected with the axle, and wherein the axle is drivingly connected with the mount such that when the gear is rotationally accelerated, the axle rotationally accelerates the mount, which rotationally accelerates the rotatable object.

In a further aspect, the object rotating system further comprises a gear rack drivingly connected with the gear such that when the gear rack is moved, the gear rack imparts a rotary motion to the gear.

In a still further aspect, the object rotating system further comprises a motor drivingly connected with the gear such that when the motor is activated, the motor imparts a rotary motion to the gear.

In a yet further aspect, the object rotating system further comprises a housing to protect the gear and axle from the environment and direct contact with a user.

In another aspect, the housing further comprises a guideway to direct the gear rack into the gear.

In another aspect, the toy further comprises a rotatable object, the rotatable object rotationally connected with the mount.

In still another aspect, the rotatable object further comprises a receiving element, and wherein the rotatable object is connected with the mount via the receiving element, and wherein the mount is rotationally connected with the receiving element of the rotatable object via a driving element, and wherein the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

In a further aspect, the edge of the driving element and the edge of the receiving element are formed as matching and interlocking shapes, such that when the edge of the driving element is matched with the edge of the receiving element, an interlocking drive connection is formed.

In another aspect, the edge of the driving element and the edge of the receiving element are formed as hook shapes, such that when the edge of the driving element is matched up with the edge of the receiving element, an interlocking drive connection is formed.

In another aspect, the rotatable object is a wheel.

In another aspect the wheel further comprises a rim, a tire, and a toy brake rotor and caliper.

In another aspect, a method of making a toy for washing a rotatable object comprises the acts of forming a base; forming a chamber supported by the base, the chamber configured to contain a rotatable object and a portion of liquid; connecting a mount with the chamber to affix the rotatable object in the chamber; and drivingly connecting an object rotating system with the mount to impart a rotary motion to the rotatable object, whereby when the rotatable object is rotated in the chamber, the liquid washes the rotatable object.

In another aspect, the method comprises the act of forming the chamber of plastic or acrylic.

In another aspect, the method comprises the act of forming the chamber from a transparent material.

In another aspect, the method comprises the act of shaping the chamber to fit a rotatable object.

In another aspect, the method comprises the act of forming the chamber with a base portion and a cover portion, the base portion connected with the base and the cover portion separable from the base portion so the rotatable object can be mounted into the chamber.

In another aspect, the method comprises the act of forming the mount with a rotating end and a locking end, the rotating end connected with a hub of a first side of the rotatable object and the locking end connected with the hub of a second side of the rotatable object, the first and second sides of the object connected with the respective rotating end and locking end of the mount at the hub of the rotatable object.

In another aspect, the method comprises the act of the positioning the mount within the chamber such that a rotatable object connected with the mount freely rotates in the chamber.

In another aspect, the method comprises the act of forming the rotating end of the mount with a driving element configured to engage a receiving element, the receiving element connected with the rotatable object to form a drive connection, such that when the driving element is rotated, the receiving element is similarly rotated.

In another aspect, the method comprises the act of forming the locking end of the mount with a movable locking shaft for rotationally engaging and applying a force to the rotatable object, the locking end adjustable between a locked position and an unlocked position, such that when the locking end is in the locked position and rotatable object is rotated in the chamber, the rotatable object cannot be released from the mount.

In another aspect, the method comprises the act of forming the locking end with a compression spring to apply a force to the locking shaft and maintain the locking shaft in a locked position, and wherein the locking shaft further comprises a handle such that a user can pull the handle to move the locking shaft from a locked position to an unlocked position in order to load a rotatable object into the chamber.

In another aspect, the method comprises the act of forming the driving element with two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

In another aspect, the method comprises the act of forming the edge of the driving element and the edge of the receiving element as matching and interlocking shapes, such that when the edge of the driving element is matched with the edge of the receiving element, an interlocking drive connection is formed.

In another aspect, the method comprises the act of forming the edge of the driving element and the edge of the receiving element as hook shapes, such that when the edge of the driving element is matched up with the edge of the receiving element, an interlocking drive connection is formed.

In another aspect, the method comprises the act of forming the object rotating system with a gear and an axle, the gear drivingly connected with the axle, and wherein the axle is drivingly connected with the mount such that when the gear is rotationally accelerated, the axle rotationally accelerates the mount, which rotationally accelerates the rotatable object.

In another aspect, the method comprises the act of forming the object rotating system further comprises a gear rack drivingly connected with the gear such that when the gear rack is moved, the gear rack imparts a rotary motion to the gear.

In another aspect, the method comprises the act of forming the object rotating system with a motor drivingly connected with the gear such that when the motor is activated, the motor imparts a rotary motion to the gear.

In another aspect, the method comprises the act of forming the object rotating system with a housing to protect the gear and axle from the environment and direct contact with a user.

In another aspect, the method comprises the act of forming the housing with a guideway to direct the gear rack into the gear.

In another aspect, the method comprises the act of forming the toy with a rotatable object, the rotatable object rotationally connected with the mount.

In another aspect, the method comprises the act of forming the rotatable object with a receiving element, and wherein the rotatable object is connected with the mount via the receiving element, and wherein the mount is rotationally connected with the receiving element of the rotatable object via a driving element, and wherein the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

In another aspect, the method comprises the act of forming the edge of the driving element and the edge of the receiving element as matching and interlocking shapes, such that when the edge of the driving element is matched with the edge of the receiving element, an interlocking drive connection is formed.

In another aspect, the method comprises the act of forming the edge of the driving element and the edge of the receiving element as hook shapes, such that when the edge of the driving element is matched up with the edge of the receiving element, an interlocking drive connection is formed.

In another aspect, the method comprises the act of forming the rotatable object as a wheel.

In another aspect, the method comprises the act of forming the wheel with a rim, a tire, and a toy brake rotor and caliper.

### BRIEF DESCRIPTION OF THE DRAWINGS

The objects, features and advantages of the present invention will be apparent from the following detailed descriptions of the disclosed aspects of the invention in conjunction with reference to the following drawings, where:

FIG. 1 is an illustration of one embodiment of the toy according to the present invention, depicting a base supporting a chamber for washing a rotatable object;

FIG. 2 is an illustration of one embodiment of the toy according to the present invention, depicting a mount to rotationally fix a rotatable object in the chamber;

FIGS. 3A-3C are illustrations of one embodiment of the toy according to the present invention, depicting the driving element of a rotating end of the mount and how the driving element forms an interlocking drive connection with a receiving element on a rotatable object;

FIG. 4 is an illustration of one embodiment of the toy according to the present invention, depicting a locking end of the mount;

FIG. 5A is an illustration of one embodiment of the toy according to the present invention, depicting the object rotation system;

FIG. 5B is an illustration of one embodiment of the toy according to the present invention, depicting a housing surrounding the object rotation system;

FIG. 5C is an illustration of one embodiment of the toy according to the present invention, depicting a gear rack penetrating the housing of the object rotation system;

FIG. 5D is an illustration of one embodiment of the toy according to the present invention, depicting a guideway to direct the gear rack into contact with the object rotation system;

FIG. 6 is an illustration of one embodiment of the toy according to the present invention, depicting a wheel being inserted into the chamber; and

FIG. 7 is an illustration of one embodiment of the toy according to the present invention, depicting a storage tank for retaining a liquid to use for washing the rotatable object.

### DETAILED DESCRIPTION

The present invention relates to a toy for washing a rotatable object by rotating the object in a chamber of liquid, and more particularly to an object rotating system for rotationally fixing the object in the chamber and rotating the object with a gear rack. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles, defined herein, may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents that are filed concurrently with this specification and are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, an introduction is provided to provide the reader with a general understanding of the present invention. Next, a description of various aspects of the present invention is provided to give an understanding of the specific details.

(1) Introduction

The present invention relates to a toy for washing a rotatable object by rotating the object in a chamber of liquid. More specifically, the toy comprises a chamber partially filled with liquid and includes a mount to rotationally fix an object into the chamber. The mount includes a driving element to drivingly connect with a receiving element on the object to form a driving connection. An object rotating system then imparts a rotary motion to the mount to rotate the object within the chamber of water so as to wash the object. The object rotating system is a gear and axle drivingly connected with a gear rack. The gear rack is pulled by a user to impart a rotary motion to the gear and axle, which then rotates the mount and thus the object. In another embodiment, the object rotating system is a gear and axle drivingly connected with a motor.

(2) Design of the Toy

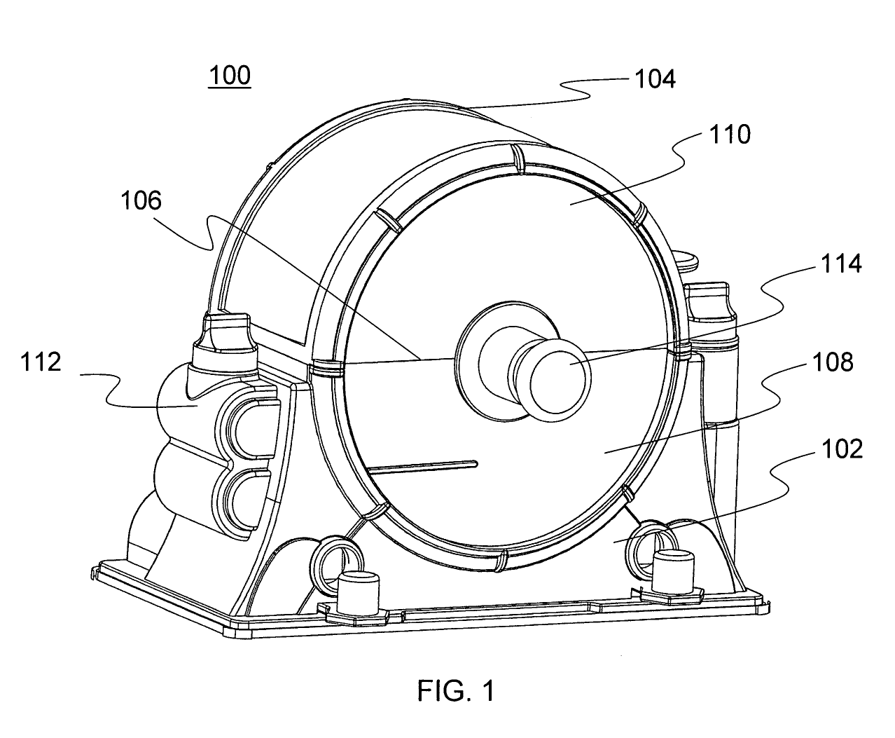

In one embodiment of the toy illustrated in FIG. 1, the toy 100 comprises a base 102 and a chamber 104. The chamber is separated along a central line 106 into a base portion 108 and a cover portion 110. The base portion 108 is configured to retain an amount of liquid, while the cover portion 110 is removable from the toy in order to load a rotatable object into the chamber 104.

In one embodiment, the chamber is made of plastic or acrylic. The base portion 108 and cover portion 110 must be connected to form a watertight seal to prevent liquid from leaking from the chamber during use. The chamber can also be transparent so that the user can watch the rotatable object being washed.

The base 102 is designed to support the chamber 104 and provide stability during use. In one embodiment, the base contains storage tanks 112 to hold an amount of liquid to be dispensed into the chamber.

FIG. 1 further illustrates a locking end 114 of a mount. The mount is formed on the outside wall of the chamber 104 along the central line 106. The rotating end of the mount (not illustrated) is formed on the opposite wall of the chamber, as will be further described below.

(3) Mount

The mount is a two-part device designed to interact with two opposing sides of a rotatable object to rotationally fix the rotatable object in the chamber. When the rotatable object is fixed into the mount, the rotatable object is free to rotate, but it will not move. The mount is positioned within the chamber such that a fixed rotatable object is suspended by the mount and does not touch any other part of the chamber.

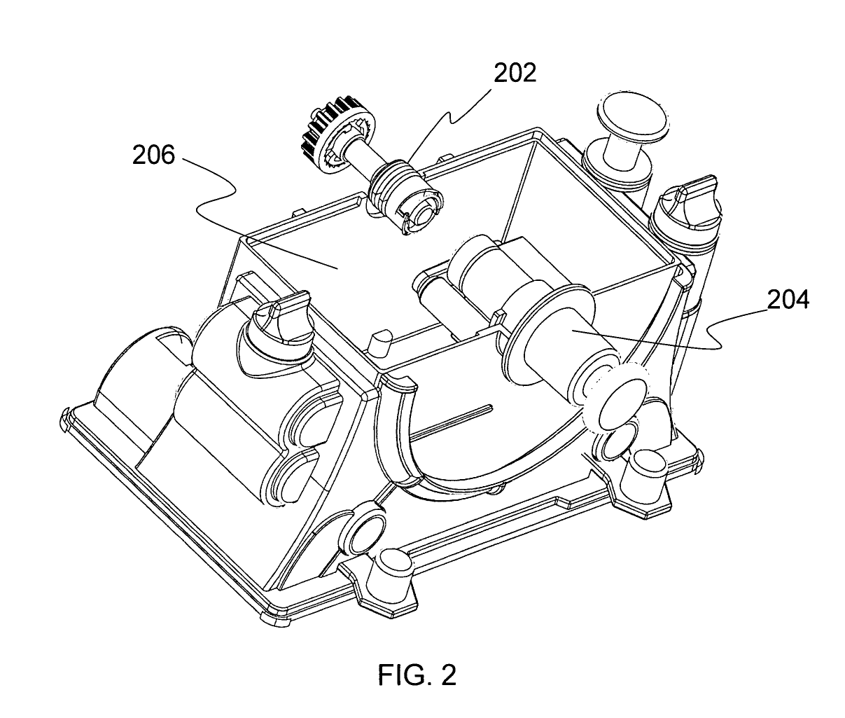

A view of the toy without the cover portion of the chamber is illustrated in FIG. 2. The mount comprises a rotating end 202 and a locking end 204. The rotatable object (not illustrated) is loaded into the chamber 206 between the rotating end 202 and locking end 204. The rotating end 202 is designed to form a driving connection with the rotatable object to impart a rotary motion to the rotatable object. The locking end 204 is designed to lock the rotatable object into place to prevent the rotatable object from releasing from the rotating end 202.

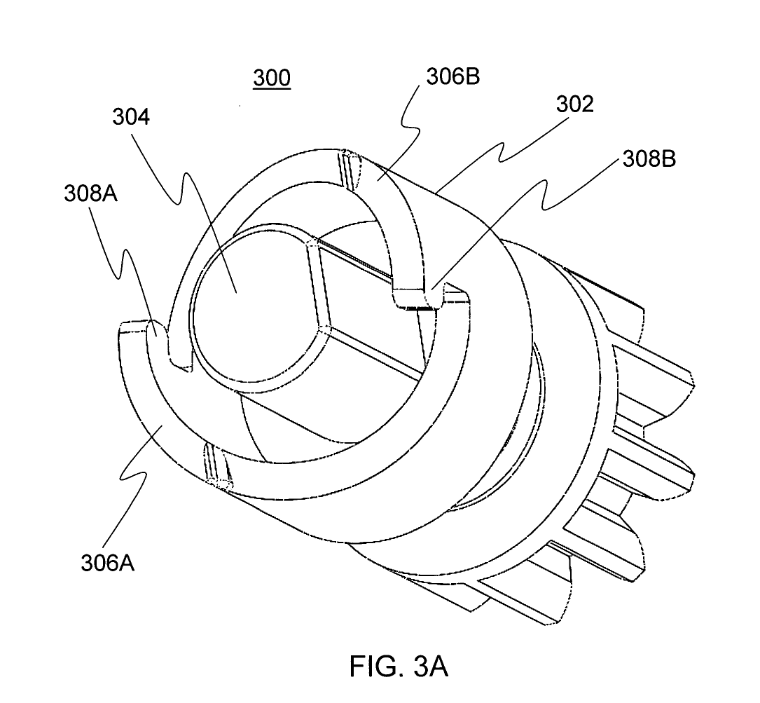

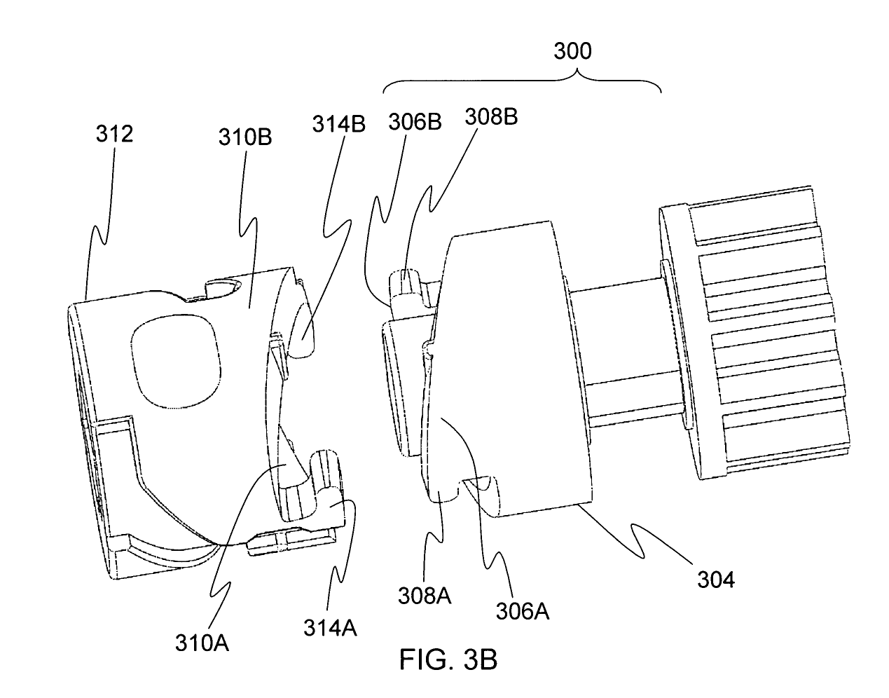

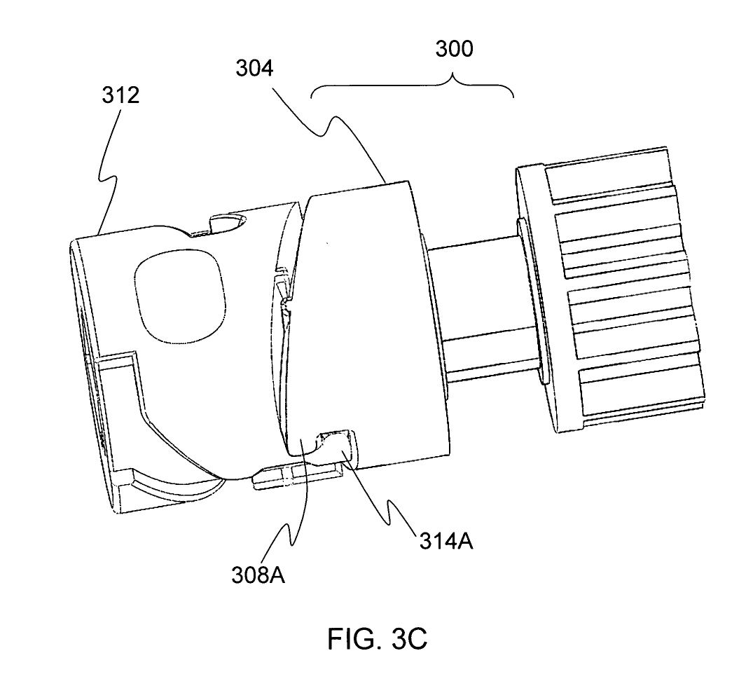

A detailed view of the rotating end 300 is illustrated in FIG. 3. The rotating end 300 further comprises a driving element 302 configured to engage a receiving element and form a drive connection, the receiving element connected with the rotatable object (not illustrated). The driving element 302 comprises two identical helical protrusions 306A and 306B, which extend outward in a parallel configuration from an axle 304 about an axis, such that the axis runs parallel with and is centered in the axle 304. The edges 308A and 308B of each of the helical protrusions 306A and 306B are formed in a hook shape.

FIG. 3B illustrates how the helical protrusions 306A and 306B of the driving element 302 are configured to match up with similar helical protrusions 310A and 310B on a receiving element 312, the receiving element 312 connected with an object to be rotated (not illustrated). In particular, the hook-shaped edges 308A and 308B of the driving element 304 are configured to match up with the hook-shaped edges 314A and 314B of the receiving element 312, forming an interlocking drive connection. The interlocking drive connection, as illustrated in FIG. 3C, allows a user to rotate the toy in any orientation and still maintain the interlocking drive connection between the driving element 304 and the receiving element 312.

Once the interlocking drive connection is made between the driving element 304 and the receiving element 312, an object rotating system can impart a rotary motion to the driving element 304 and thereby rotate the rotatable object connected with the receiving element 312.

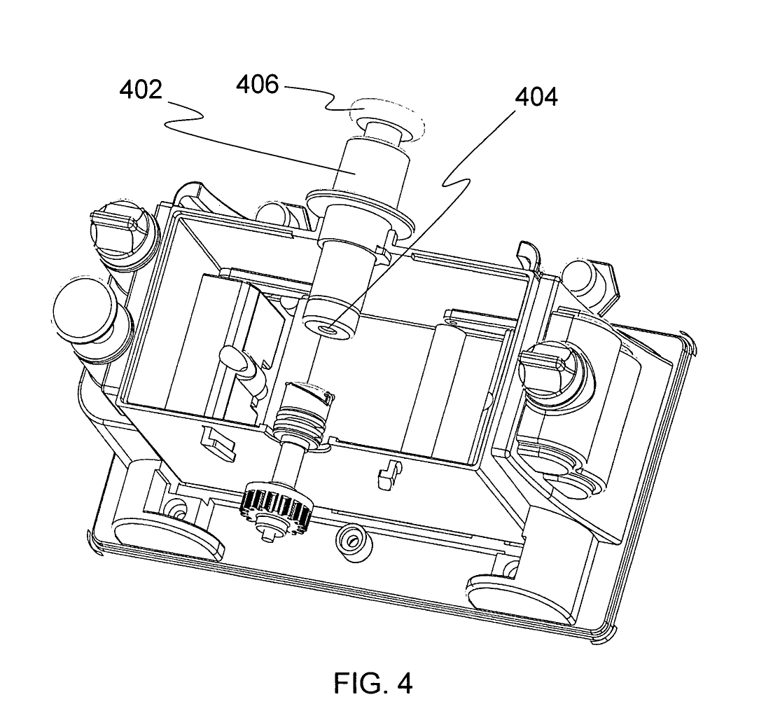

The locking end 402 of the mount is illustrated in FIG. 4. The locking end 402 comprises a movable locking shaft 404 that rotationally engages the rotatable object (not illustrated). The locking shaft 404 is configured to apply a force to the rotatable object. The locking shaft 404 allows the rotatable object to rotate but preserves the drive connection between the driving element and the receiving element, which would otherwise be severed once the rotary movement being applied to the rotating end ceases. The locking end 402 has a locked position and an unlocked position, the locked position existing when the locking shaft 404 is connected with the rotatable object, and the unlocked position existing when the locking shaft 404 is pulled away from the rotatable object.

In one embodiment, the locking shaft 404 is configured with a compression spring (not illustrated) such that the compression spring compresses the locking shaft 404 into the locked position. The locking shaft 404 further comprises a handle 406 which a user can pull to place the locking shaft 404 in an unlocked position in order to load a rotatable object into the chamber. Once the handle 406 is released, the compression spring compresses the locking shaft 404 into a locked position, which applies a force to the rotatable object to fix the rotatable object in place. FIG. 4 shows the locking end 402 in an unlocked position, where the locking shaft 404 is recessed into the locking end 402.

(4) Object Rotating System

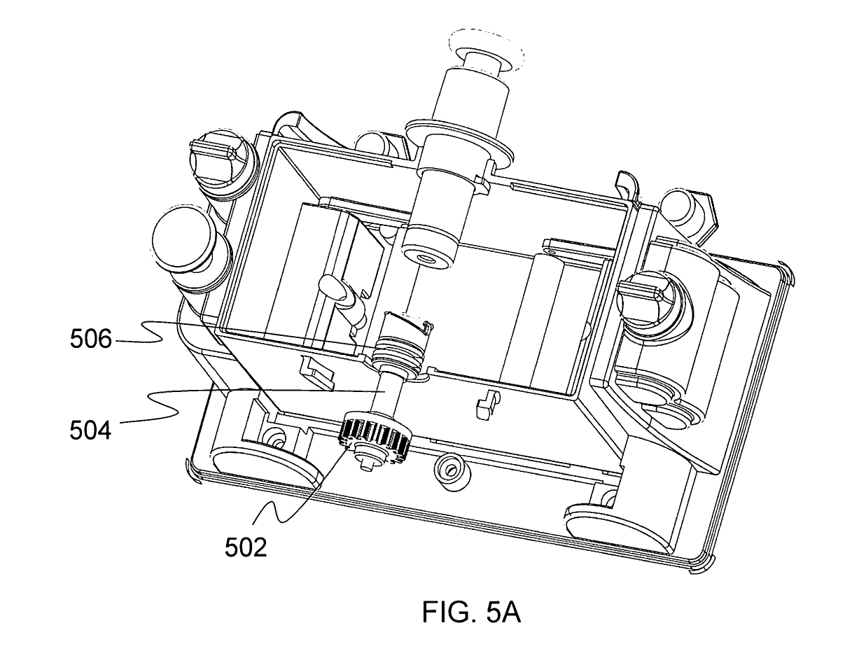

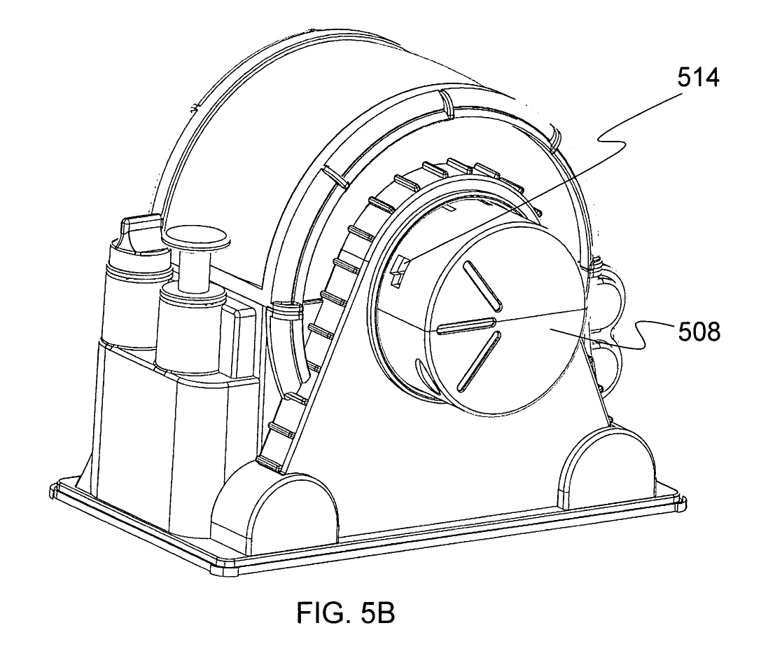

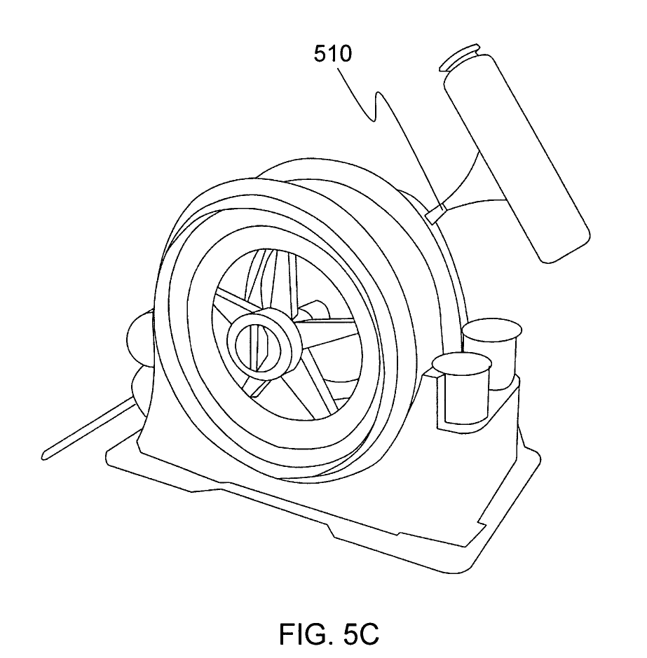

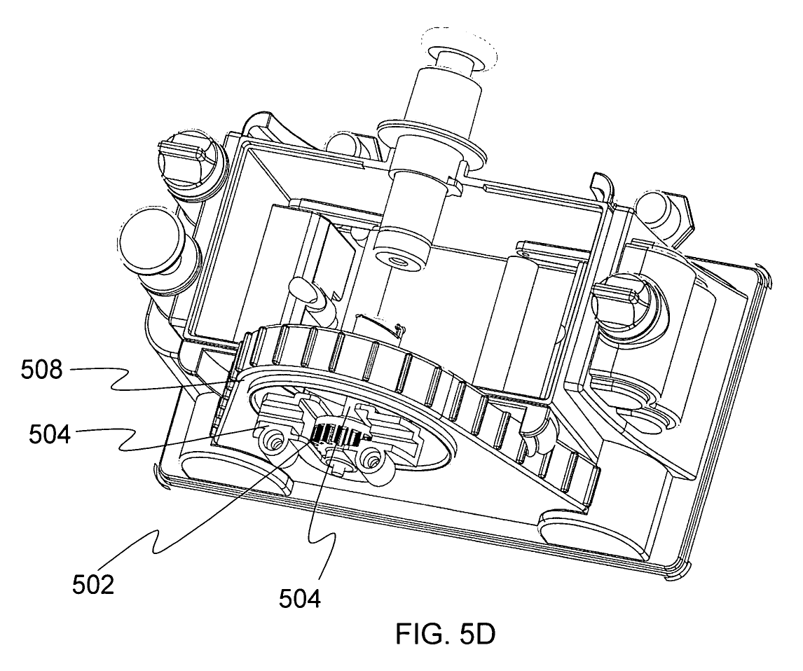

In one embodiment, the object rotating system comprises a gear and an axle; the gear being drivingly connected with the axle, and the axle being drivingly connected with the rotating end of the mount. FIG. 5A illustrates the object rotating system, including the gear 502 and axle 504. The axle is drivingly connected to the rotating end 506 of the mount, such that when the object rotating system imparts a rotary movement to the rotating end 506, the connected rotatable object (not illustrated) is rotated.

FIG. 5B illustrates another embodiment of the object rotating system wherein a housing 508 surrounds the object rotating system. The object rotating system also comprises a gear rack 510, as shown in FIG. 5C, which is drivingly connected with the gear 502 such that when a user moves the gear rack 510, the gear rack 510 imparts a rotary motion to the gear. The gear rack 510 is pulled to impart a rotary motion in one direction, and pushed to impart a rotary motion in the opposite direction. FIG. 5D further illustrates how a guideway 512 can be mounted around the gear 502 to direct the gear rack 510 into a driving connection with the gear 502. The housing 508 is further modified to provide for an opening 514 for the gear rack to enter the guideway 512, as illustrated in FIG. 5B.

The object rotating system can be further modified, in another embodiment, to permit the user to continuously rotate the object in one direction by continuously pulling the gear rack without removing the gear rack from the guideway. This continuous rotation in one direction can be achieved in a variety of ways. In one embodiment, a clutch mechanism disengages the gear rack from the gear when the gear rack is pushed into the guideway. In another embodiment, the teeth of the gear rack can be extended at a slanted angle such that the teeth only engage the gear when moving in one direction, while the movement of the gear rack in an opposite direction does not engage the gear.

In another embodiment of the gear rotating system, the gear rack is replaced with a motor, which can be activated to impart a rotary motion to the gear, axle, and rotating end of the mount. One skilled in the art will appreciate that there are many possible ways to impart a rotary motion to the gear.

(5) Rotatable Object

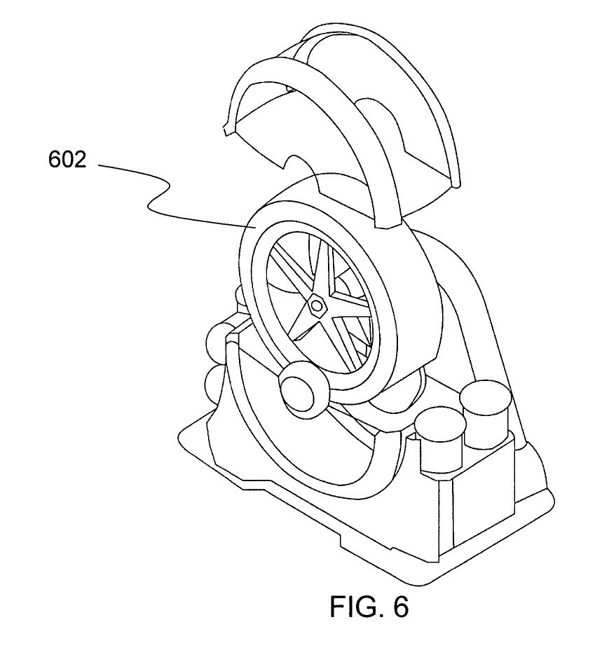

The rotatable object can be any object configured to interact with the mount. In one embodiment, as illustrated in FIG. 6, the rotatable object is a wheel 602. The wheel may further comprise a rim, tire, or toy brake disc to give the tire the look of an automobile wheel.

(6) Liquid

The liquid to be deposited into the chamber may be any type of liquid useful for cleaning a rotatable object, and will vary depending on the composition of the object. However, in one embodiment, where the rotatable object is a wheel, it is desirable to use water or a mixture of water and detergent to clean the tire. As the invention provides for the device as a toy, care should be taken not to use an abrasive or harmful liquid that may injure a child.

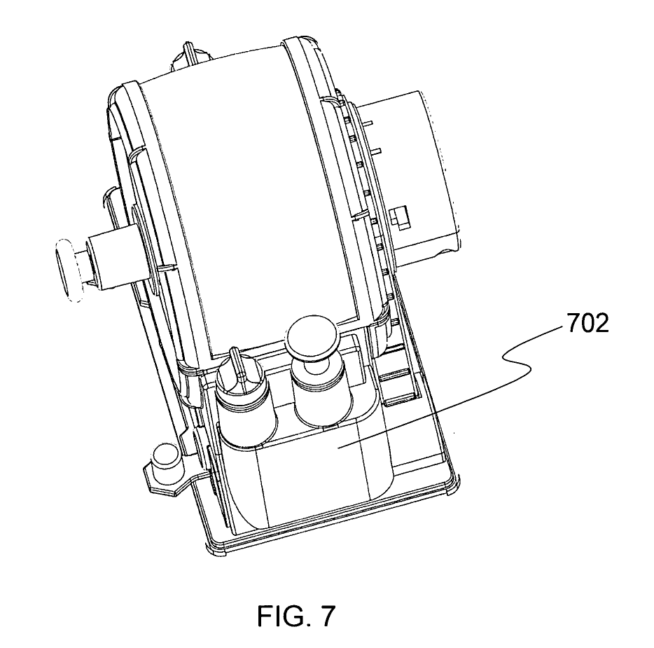

In another embodiment, as illustrated in FIG. 7, a storage tank 702 is used to store liquid for later use. The storage tank 702 can also be configured to directly deposit the liquid into the chamber.

What is claimed is:

1. A toy for washing a rotatable object, the toy comprising:
a base;
a chamber supported by the base, the chamber configured to contain a rotatable object and a portion of liquid;
a mount connected with the chamber to affix the rotatable object in the chamber; and
an object rotating system drivingly connected with the mount to impart a rotary motion to the rotatable object, whereby when the rotatable object is rotated in the chamber, the liquid washes the rotatable object.

2. The toy as set forth in claim 1, wherein the chamber is formed of plastic or acrylic.

3. The toy as set forth in claim 2, wherein the chamber is transparent.

4. The toy as set forth in claim 3, wherein the chamber is shaped to fit a rotatable object.

5. The toy as set forth in claim 4, wherein the chamber further comprises a base portion and a cover portion, the base portion connected with the base and the cover portion separable from the base portion so the rotatable object can be mounted into the chamber.

6. The toy as set forth in claim 1, wherein the mount further comprises a rotating end and a locking end, the rotating end connected with a hub of a first side of the rotatable object and the locking end connected with the hub of a second side of the rotatable object, the first and second sides of the object connected with the respective rotating end and locking end of the mount at the hub of the rotatable object.

7. The toy as set forth in claim 6, wherein the mount is positioned within the chamber such that a rotatable object connected with the mount freely rotates in the chamber.

8. The toy as set forth in claim 7, wherein the rotating end of the mount comprises a driving element configured to engage a receiving element, the receiving element connected with the rotatable object to form a drive connection, such that when the driving element is rotated, the receiving element is similarly rotated.

9. The toy as set forth in claim 8, wherein the locking end of the mount comprises a movable locking shaft for rotationally engaging and applying a force to the rotatable object, the locking end adjustable between a locked position and an unlocked position, such that when the locking end is in the locked position and rotatable object is rotated in the chamber, the rotatable object cannot be released from the mount.

10. The toy as set forth in claim 9, wherein the locking end further comprises a compression spring to apply a force to the locking shaft and maintain the locking shaft in a locked position, and wherein the locking shaft further comprises a handle such that a user can pull the handle to move the locking shaft from a locked position to an unlocked position in order to load a rotatable object into the chamber.

11. The toy as set forth in claim 10, wherein the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

12. The toy as set forth in claim 11, wherein the edge of the driving element and the edge of the receiving element are formed as matching and interlocking shapes, such that when the edge of the driving element is matched with the edge of the receiving element, an interlocking drive connection is formed.

13. The launcher as set forth in claim 12, wherein the edge of the driving element and the edge of the receiving element are formed as hook shapes, such that when the edge of the driving element is matched up with the edge of the receiving element, an interlocking drive connection is formed.

14. The toy as set forth in claim 1, wherein the object rotating system further comprises a gear and an axle, the gear drivingly connected with the axle, and wherein the axle is drivingly connected with the mount such that when the gear is rotationally accelerated, the axle rotationally accelerates the mount, which rotationally accelerates the rotatable object.

15. The toy as set forth in claim 14, wherein the object rotating system further comprises a gear rack drivingly connected with the gear such that when the gear rack is moved, the gear rack imparts a rotary motion to the gear.

16. The toy as set forth in claim 15, wherein the object rotating system further comprises a motor drivingly connected with the gear such that when the motor is activated, the motor imparts a rotary motion to the gear.

17. The toy as set forth in claim 16, wherein the object rotating system further comprises a housing to protect the gear and axle from the environment and direct contact with a user.

18. The toy as set forth in claim 17, wherein the housing further comprises a guideway to direct the gear rack into the gear.

19. The toy as set forth in claim 18, wherein the toy further comprises a rotatable object, the rotatable object rotationally connected with the mount.

20. The toy as set forth in claim 19, wherein the rotatable object further comprises a receiving element, and wherein the rotatable object is connected with the mount via the receiving element, and wherein the mount is rotationally connected with the receiving element of the rotatable object via a driving element, and wherein the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

21. The toy as set forth in claim 20, wherein the edge of the driving element and the edge of the receiving element are formed as matching and interlocking shapes, such that when the edge of the driving element is matched with the edge of the receiving element, an interlocking drive connection is formed.

22. The toy as set forth in claim 21, wherein the edge of the driving element and the edge of the receiving element are formed as hook shapes, such that when the edge of the driving element is matched up with the edge of the receiving element, an interlocking drive connection is formed.

23. The toy as set forth in claim 22, wherein the rotatable object is a wheel.

24. The toy as set forth in claim 23, wherein the wheel further comprises a rim, a tire, and a toy brake rotor and caliper.

25. A method of making a toy for washing a rotatable object, the method comprising the act of:
forming a base;
forming a chamber supported by the base, the chamber configured to contain a rotatable object and a portion of liquid;
connecting a mount with the chamber to affix the rotatable object in the chamber; and
drivingly connecting an object rotating system with the mount to impart a rotary motion to the rotatable object, whereby when the rotatable object is rotated in the chamber, the liquid washes the rotatable object.

26. The method as set forth in claim 25, further comprising the act of forming the chamber of plastic or acrylic.

27. The method as set forth in claim 26, further comprising the act of forming the chamber from a transparent material.

28. The method as set forth in claim 27, further comprising the act of shaping the chamber to fit a rotatable object.

29. The method as set forth in claim 28, further comprising the act of forming the chamber with a base portion and a cover portion, the base portion connected with the base and the cover portion separable from the base portion so the rotatable object can be mounted into the chamber.

30. The method as set forth in claim 25, further comprising the act of forming the mount with a rotating end and a locking end, the rotating end connected with a hub of a first side of the rotatable object and the locking end connected with the hub of a second side of the rotatable object, the first and second sides of the object connected with the respective rotating end and locking end of the mount at the hub of the rotatable object.

31. The method as set forth in claim 30, further comprising the act of the positioning the mount within the chamber such that a rotatable object connected with the mount freely rotates in the chamber.

32. The method as set forth in claim 31, further comprising the act of forming the rotating end of the mount with a driving element configured to engage a receiving element, the receiving element connected with the rotatable object to form a drive connection, such that when the driving element is rotated, the receiving element is similarly rotated.

33. The method as set forth in claim 32, further comprising the act of forming the locking end of the mount comprises a movable locking shaft for rotationally engaging and applying a force to the rotatable object, the locking end adjustable between a locked position and an unlocked position, such that when the locking end is in the locked position and rotatable object is rotated in the chamber, the rotatable object cannot be released from the mount.

34. The method as set forth in claim 33, further comprising the act of forming the locking end with a compression spring to apply a force to the locking shaft and maintain the locking shaft in a locked position, and wherein the locking shaft further comprises a handle such that a user can pull the handle to move the locking shaft from a locked position to an unlocked position in order to load a rotatable object into the chamber.

35. The method as set forth in claim 34, further comprising the act of forming the driving element with two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

36. The method as set forth in claim 35, further comprising the act of forming the edge of the driving element and the edge of the receiving element as matching and interlocking shapes, such that when the edge of the driving element is matched with the edge of the receiving element, an interlocking drive connection is formed.

37. The launcher as set forth in claim 36, further comprising the act of forming the edge of the driving element and the edge of the receiving element as hook shapes, such that when the edge of the driving element is matched up with the edge of the receiving element, an interlocking drive connection is formed.

38. The method as set forth in claim 25, further comprising the act of forming the object rotating system with a gear and an axle, the gear drivingly connected with the axle, and wherein the axle is drivingly connected with the mount such that when the gear is rotationally accelerated, the axle rotationally accelerates the mount, which rotationally accelerates the rotatable object.

39. The method as set forth in claim 38, further comprising the act of forming the object rotating system further comprises a gear rack drivingly connected with the gear such that when the gear rack is moved, the gear rack imparts a rotary motion to the gear.

40. The method as set forth in claim 39, further comprising the act of forming the object rotating system with a motor drivingly connected with the gear such that when the motor is activated, the motor imparts a rotary motion to the gear.

41. The method as set forth in claim 40, further comprising the act of forming the object rotating system with a housing to protect the gear and axle from the environment and direct contact with a user.

42. The method as set forth in claim 41, further comprising the act of forming the housing with a guideway to direct the gear rack into the gear.

43. The method as set forth in claim 42, further comprising the act of forming the toy with a rotatable object, the rotatable object rotationally connected with the mount.

44. The method as set forth in claim 43, further comprising the act of forming the rotatable object with a receiving element, and wherein the rotatable object is connected with the mount via the receiving element, and wherein the mount is rotationally connected with the receiving element of the rotatable object via a driving element, and wherein the driving element comprises two substantially helical protrusions extending in a parallel configuration from the driving element about an axis, the axis running substantially parallel to and substantially centered in the driving element, and wherein the receiving element of the rotatable object is similarly configured with two substantially helical protrusions extending outward in parallel configuration about an axis, the axis running substantially parallel to and substantially centered in the receiving element, and wherein the two substantially helical protrusions of each of the driving element and receiving element has an edge that runs parallel to the axis of the respective driving element and receiving element, such that the edge of the driving element rests flush against the edge of the receiving element, forming a drive connection which allows the rotation of the driving element to rotate the receiving element.

45. The method as set forth in claim 44, further comprising the act of forming the edge of the driving element and the edge of the receiving element as matching and interlocking shapes, such that when the edge of the driving element is matched with the edge of the receiving element, an interlocking drive connection is formed.

46. The method as set forth in claim 45, further comprising the act of forming the edge of the driving element and the edge of the receiving element as hook shapes, such that when the edge of the driving element is matched up with the edge of the receiving element, an interlocking drive connection is formed.

47. The method as set forth in claim 46, further comprising the act of forming the rotatable object as a wheel.

48. The method as set forth in claim 47, further comprising the act of forming the wheel with a rim, a tire, and a toy brake rotor and caliper.
